(19) United States
(12) Patent Application Publication
(10) Pub. No.: US 2025/0234019 A1
(43) Pub. Date: Jul. 17, 2025

(54) SYSTEM AND METHOD FOR REAL-TIME MULTI-RESOLUTION VIDEO STREAM TILE ENCODING WITH SELECTIVE TILE DELIVERY BY AGGREGATOR-SERVER TO THE CLIENT BASED ON USER POSITION AND DEPTH REQUIREMENTS

(71) Applicant: SUMMIT-TECH MULTIMEDIA COMMUNICATIONS INC., Montreal (CA)

(72) Inventors: Ahmad (safa) VAKILI, Montreal (CA); Alido DI GIOVANNI, Montreal (CA); Geoffrey George WRIGHT, Montreal (CA)

(21) Appl. No.: 18/682,857

(22) PCT Filed: Aug. 9, 2022
(86) PCT No.: PCT/CA2022/051222

§ 371 Date: Feb. 9, 2024

Related U.S. Application Data
(60) Provisional application No. 63/231,218, filed on Aug. 9, 2021.

(51) Int. Cl. H04N 19/31; H04N 19/174; H04N 19/88

(52) U.S. Cl. CPC H04N 19/31; H04N 19/174; H04N 19/88

(57) ABSTRACT

A system and method for real-time multi-resolution video stream tile encoding with selective tile delivery by aggregator-server to a client based on user position and depth requirements. The system and method use common consumer GPUs to tile encode real time high-resolution videos which are codec-standard-compliant and use minimum encoder sessions, provide a seamless multi resolution stream switching method based on the proposed tile encoded stream.

### CROSS-REFERENCE TO RELATED APPLICATIONS

This application claims the benefits of U.S. provisional patent application No. 63/231,218 filed on Aug. 9, 2021, which is herein incorporated by reference.

### TECHNICAL FIELD

The present disclosure relates to a system and method for real-time multi-resolution video stream tile encoding with selective tile delivery by aggregator-server to the client based on user position and depth requirements.

### BACKGROUND

360-degree high resolution videos (e.g., 4k or 8k) with high frame rate are increasingly used in Virtual Applications to provide an immersive experience. With this comes a high price for computational complexity to process the data and the high bandwidth requirement to deliver the video in real time to the viewer. Yet, the challenge is to provide the user with a good perceived experience while saving system resources and Internet bandwidth.

Humans only have a limited Field of View (FoV), e.g., 120°; at any point in time, a user can only view a portion (i.e., ⅓) of the whole captured and processed 360-degree scene. So, to reduce the bandwidth and computational complexity at the user side, transferring a multi-quality stream which delivers high quality video only to the user's FoV is the common approach. To do so, the tile encoding has been adopted as a mechanism of splitting sections of the video between high quality and low quality, thus ensuring, only the currently viewed portion of the video is delivered in high quality, while the unseen areas are delivered at lower quality, reducing bandwidth and computational requirements.

Encoding very high-resolution video in real time is typically possible through hardware encoders and decoders (i.e., GPUs or high-end CPUs). Although most modern hardware supports the decoding of tiled streams, consumer versions of GPUs do not support standard tile encoding. To address this shortcoming, it has been suggested by some studies that all the tiles within a video stream can be separated out and encoded completely independently rather than one complete stream of sub-divided tiles (i.e., standard tile encoding). In this case, each tile should be also decoded separately and independently to eliminate the error propagation. Such distortion only occurs at the border of tiles when the separated encoded tiles are treated as if they were encoded in the standard manner.

However, this operation requires a high computational power which is challenging for typical end-user devices such as mobile phones. In addition, the bit rate (efficiency) of this tiled encoded stream is not as good as a codec-standard tiled encoded stream. Accordingly, there is a need for a system and method for providing 360-degree high resolution videos with high frame rate without requiring high computational power.

### SUMMARY

There is provided method for real-time multi-resolution video stream tile encoding, comprising the steps of:
receiving a video feed;
performing stitching on the received video feed;
separating the stitched video feed into a high-resolution stitched video feed and a stitched low-resolution video feed;
for the high-resolution stitched video feed, performing the sub-steps of:
tiling the high-resolution stitched video feed;
stacking the tiled high-resolution stitched video feed into at least one stack;
slice encoding each of the at least one stack of tiled high-resolution stitched video feed into a high-quality slice encoded tiled high-resolution stitched video feed and a low-quality slice encoded tiled high-resolution stitched video feed;
for the low-resolution stitched video feed, performing the sub-steps of:
tiling the low-resolution stitched video feed;
stacking the tiled low-resolution stitched video feed into at least one stack;
slice encoding each of the at least one stack of tiled low-resolution stitched video feed into a high-quality slice encoded tiled low-resolution stitched video feed and a low-quality slice encoded tiled low-resolution stitched video feed;
interleaving the high-quality slice encoded tiled high-resolution stitched video feed, the low-quality slice encoded tiled high-resolution stitched video feed, the high-quality slice encoded tiled low-resolution stitched video feed and the low-quality slice encoded tiled low-resolution stitched video feed;
aggregating the interleaved video feed into a full frame video feed;
providing the aggregated interleaved video feed to a user device with a high-quality version or low-quality version according to received user requirements from the user device;
wherein the user device separates, decodes and unstacks each of the at least one stack, which are then stitched together and then played back through a display of the user device.

There is provided a system for real-time multi-resolution
video stream tile encoding, comprising:
a user device including:
a user interface configured to provide user requirements;
a display;
a camera generating a video feed;
a streaming server including:
a capturing module configured to receive the video feed;
a pre-processing module configured to perform the step of:
stitching on the received video feed;
an encoder module configured to perform the steps of:
separating the stitched video feed into a high-resolution stitched video feed and a stitched low-resolution video feed;
for the high-resolution stitched video feed, performing the sub-steps of:
tiling the high-resolution stitched video feed;
stacking the tiled high-resolution stitched video feed into at least one stack;
slice encoding each of the at least one stack of tiled high-resolution stitched video feed into a high-quality slice encoded tiled high-resolution stitched video feed and a low-quality slice encoded tiled high-resolution stitched video feed;
for the low-resolution stitched video feed, performing the sub-steps of:
tiling the low-resolution stitched video feed;
stacking the tiled low-resolution stitched video feed into at least one stack;
slice encoding each of the at least one stack of tiled low-resolution stitched video feed into a high-quality slice encoded tiled low-resolution stitched video feed and a low-quality slice encoded tiled low-resolution stitched video feed;
interleaving the high-quality slice encoded tiled high-resolution stitched video feed, the low-quality slice encoded tiled high-resolution stitched video feed, the high-quality slice encoded tiled low-resolution stitched video feed and the low-quality slice encoded tiled low-resolution stitched video feed;
an aggregator server configured to perform the steps of:
aggregating the interleaved video feed into a full frame video feed;
providing the aggregated interleaved video feed to the user device with a high-quality version or low-quality version according to received user requirements from the user device;
wherein the user device separates, decodes and unstacks each of the at least one stack, which are then stitched together and then played back through the display of the user device.

There is also provided a system for real-time multi-resolution video stream tile encoding as above wherein the user interface is selected from a group consisting of a touch screen and motion sensors.

There is further provided a method and system for real-time multi-resolution video stream tile encoding as above wherein the video feed is a high-quality and high-resolution video feed.

There is also provided a method and system for real-time multi-resolution video stream tile encoding as above further performing the steps of adjusting light and color, and performing scaling after the step of performing stitching on the received video feed.

There is further provided a method and system for real-time multi-resolution video stream tile encoding as above wherein the user device is configured to pre-processes the received aggregated interleaved video feed to determine any resolution changes; and then re-establish its decoding, stitching, and displaying respective to received resolution information without any interruption in the playback.

There is also provided a method and system for real-time multi-resolution video stream tile encoding as above wherein each of the high-resolution stitched video feed and the low-resolution stitched video feed are stacked in two stacks, each stack containing multiple tiles in a vertical format.

### BRIEF DESCRIPTION OF THE FIGURES

Embodiments of the disclosure will be described by way of examples only with reference to the accompanying drawing, in which:

FIG. 1 is a schematic representation of the system for real-time multi-resolution video stream tile encoding in accordance with an illustrative embodiment of the present disclosure;

FIG. 2 is a sample 360-degree frame from FIG. 1;

FIG. 3. is an example of distortion and artifacts created when a regular decoder decodes a stream where each portion of the original frame is encoded separately and independently;

FIG. 4 is a comparison between tile encoding and slice

encoding features;

FIG. 5 is an illustration of the raw frame preprocessing to two stacks of tiles;

FIG. 6 is a schematic representation of the role of the aggregator to select the proper High Quality (HQ) and Low Quality (LQ) tiles based on the user's head position (FoV) to generate the final bitstream;

FIG. 7 is a schematic representation of the resolution

transition at the aggregator; and

FIG. 8 is a flow diagram of the real-time multi-resolution video stream tile encoding process in accordance with the illustrative embodiment of the present disclosure.

Similar references used in different Figures denote similar

components.

### DETAILED DESCRIPTION

Generally stated, the non-limitative illustrative embodiments of the present disclosure provide system and method for real-time multi-resolution video stream tile encoding with selective tile delivery by aggregator-server to the client based on user position and depth requirements.

The system and method use common consumer GPUs to tile encode real time high-resolution videos which are codec-standard-compliant and use minimum encoder sessions. The system and method also provide a seamless multi resolution stream switching method based on the proposed tile encoded stream.

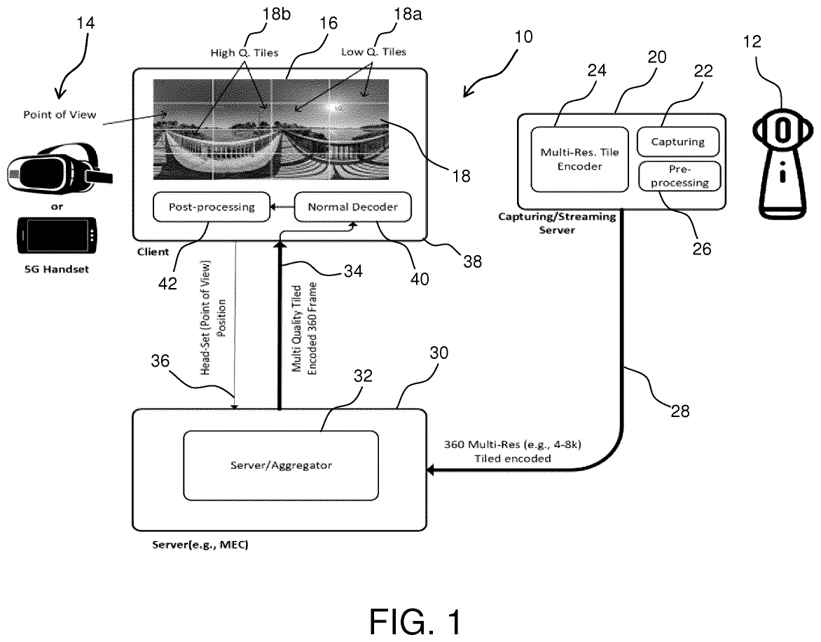

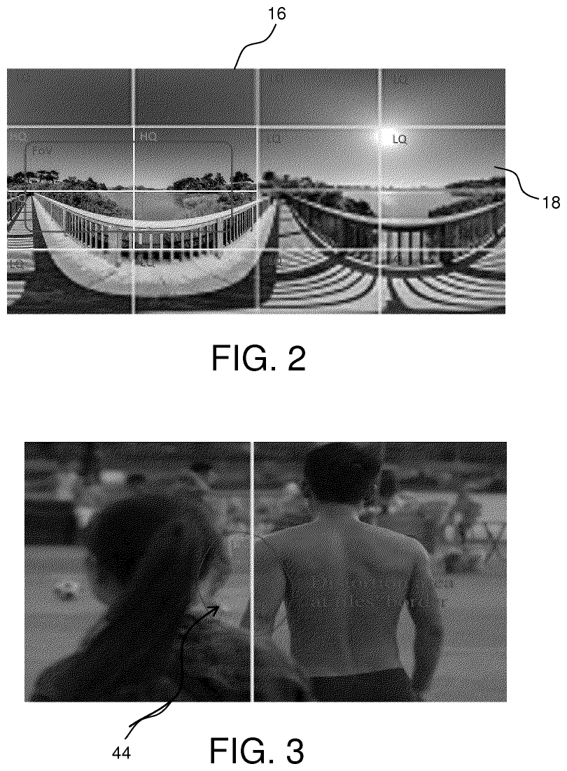

FIG. 1 shows the system for real-time multi-resolution video stream tile encoding 10 starting from the video input from a camera 12 (capture) to the end-user display 14 showing a Field of View (FoV) frame 16 (shown in more details in FIG. 2), separated into tiles 18. To this end, the camera 12 input is provided to the capturing/streaming server 20, which includes a capturing 22, pre-processing 24 and multi-resolution tile encoder 26 modules. The resulting 360 multi-resolution (e.g., 4-8k) tile encoded stream is then received by the multi-access edge computing (MEC)/aggregator server 30, which includes an aggregator module 32 that produces a multi-quality tiled encoded 360 frame stream 34 in accordance with a point of view position signal 36 provided by the client device 38.

From the multi-quality tiled encoded 360 frame 34, the client device 38 displays the FoV through the end-user display 14 by decoding the multi-quality tiled encoded 360 frame 34 via the decoder 40 and post-processing 42 modules. The quality of tiles is adjusted by the aggregator 32 for the FoV and the rest of areas of 360 frame in accordance with the point of view position signal 36 provided by a client device 38 user interface, for example a touch screen, motion sensors, etc.

Codec standards like HEVC or H264 include tile encoding but, due to its complexity, it has not been widely implemented in consumer hardware encoders yet. For the same reason, software encoders are not able to tile encode the high resolution-videos in real time on most consumer machines.

Referring to FIG. 3, there is shown an example of distortion and artifacts 44 created when a regular decoder decodes a stream where each portion of the original frame is encoded separately and independently.

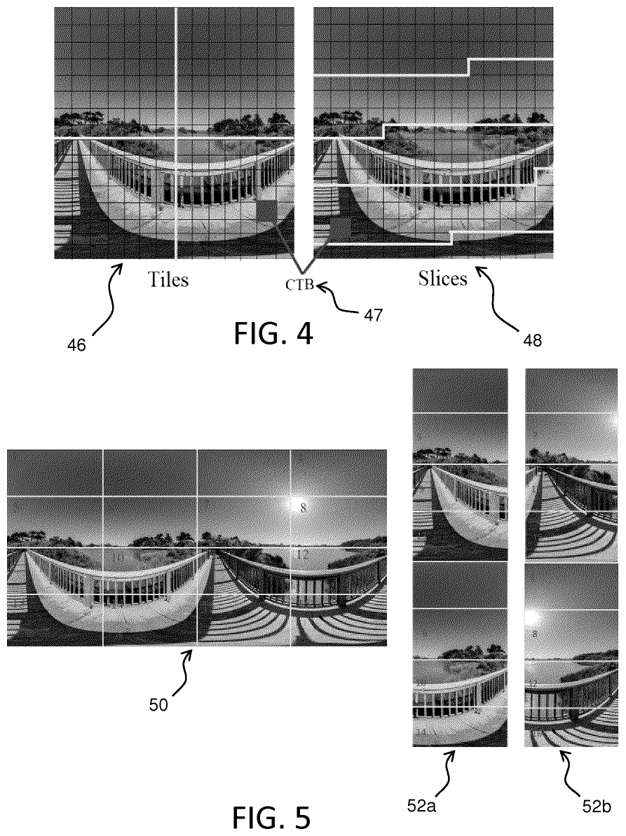

The system and method for real-time multi-resolution video stream tile encoding 10 in accordance with the illustrative embodiment of the present disclosure uses encoding based on the consumer GPUs' slice encoding feature. Referring now to FIG. 4, there is shown the difference between tile encoding 46 and slice encoding 48 features. As depicted in FIG. 4, slices contain coded tree blocks (CTB) 47 which follow raster scan order within a frame. Accordingly, simple slice encoding of the complete 360 frame does not fulfill the equal size rectangular tiles requirement.

In the illustrative embodiment, in order to use the slice encoding feature of consumer GPUs, the video raw frame is first stacked into two stacks of tiles (e.g., 1920×7680 for 8K and 960×3840 for 4K). It is to be understood, however, that in alternative embodiments the video raw frame may be stacked into 1, 2 or more stacks of tiles.

After preprocessing, shown in FIG. 5, the raw captured video and some minor modifications to the encoder, the real-time tile encoding becomes possible with a very common consumer GPUs.

With reference to FIG. 5, to tile encode frame 50 into two stacks 52a, 52b with two different qualities, just four encoder sessions are required rather than the 32 encoder sessions required by the method with separated encoded tiles. each encoder module 26 encodes a stack with eight slices (i.e., tiles) instead of eight encoders for eight tiles. Particularly, the system and method for real-time multi-resolution video stream tile encoding 10 enables a reassembling operation on the decoder 40 side, which is codec (e.g., HEVC) compliant, and works on a high syntax level in the bitstream. As a result, no entropy en/decoding is necessary, which makes the operation much less complex for both encoder 22 (capture side) and decoder 40 (end user side). With this technique only two decoder sessions (instead of 16 independent decoders) are needed to decode two stacks of tiles 52a, 52b. Then, a simple post processing action 42 can generate the proper 360-degree frame 16.

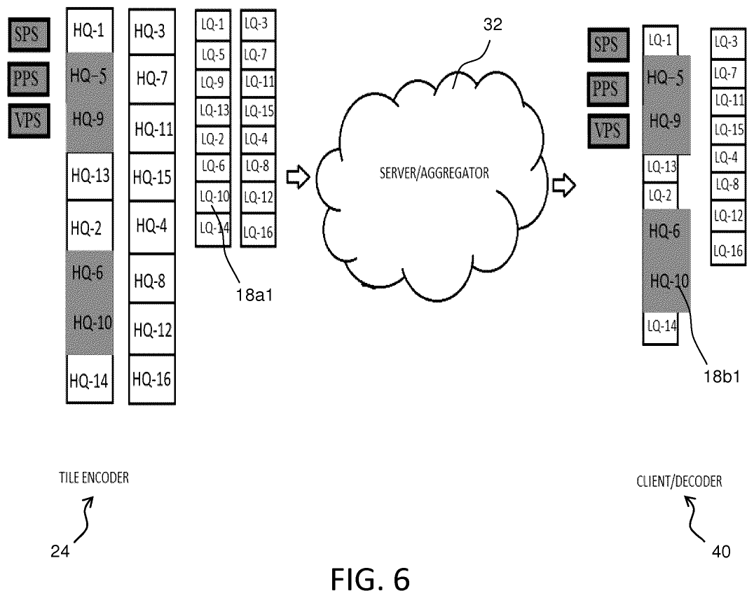

Referring now to FIG. 6, there is shown the role of the aggregator 32 to select the proper High Quality (HQ) and Low Quality (LQ) tiles and to generate for the final bitstream, which is 100% decodable by any normal decoders, e.g., decoder 40.

Since all the tiles are of the same resolution, changing (replacing) the LQ and HQ tiles can happen on the fly at any time, in real-time, and it does not need to be at I-Frames.

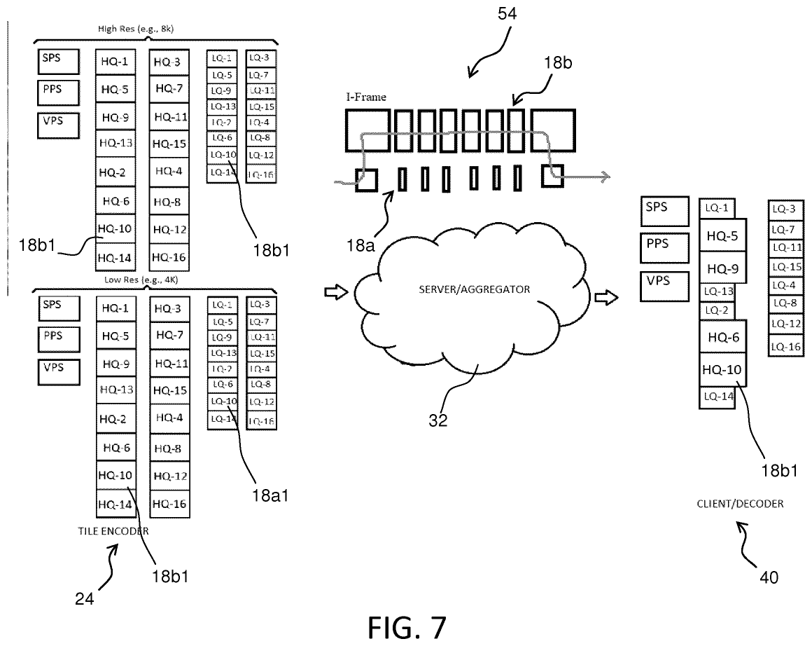

In addition, since the FoV is usually a limited area on a small display device 14 (e.g., mobile phones), very high-resolution content is not needed for common use cases. But in certain cases, like zooming into a specific area of the content for different reasons (e.g., reading a text or scanning a QR-Code within a video stream), a high quality/resolution stream can deliver better user experience. In the multi-resolution video tile encoding process of the present system and method for real-time multi-resolution video stream tile encoding 10, the capturing/streaming server 20 can seamlessly switch between different resolutions based on user needs without switching the streams and tearing down and re-stablishing a new connection. The same aggregator 32 which is used for selecting the proper tiles 18 to generate the desired stream can simply replace all the lower resolution tiles 18a1 with their equivalent high-resolution tiles 18b1. This replacement happens at the I-Frame moment. The aggregator 32 also replaces the SPS/PPS to let the decoder 40 know that the resolution has changed. FIG. 7 shows the resolution transition 54 at the aggregator 32.

Since the system and method for real-time multi-resolution video stream tile encoding 10 is implemented in bitstream syntax, the whole pipeline (capturing, multi-quality and multi-resolution tile encoding, publishing, server, aggregation, receiving, and decoding) needs the least computational resources. Furthermore, the capturing/streaming 20 and multi-access edge computing (MEC)/aggregator 30 (i.e., aggregator 32) servers can now support multi streams.

All of the bitstream information, such as the number of tiles, stacks, and supported resolution, is transferred between encoder 24, aggregator 32, and decoder 40 as the meta data in the video stream (e.g., custom SEI NAL unit in H264 or HEVC). Therefore, the system and method for real-time multi-resolution video stream tile encoding 10 in accordance with the illustrative embodiment of the present disclosure are transmission protocol agnostic.

The main advantages of system and method for real-time multi-resolution video stream tile encoding 10 are as follows:
allow a saving of up 90% of the bitrate of a 360° stream, depending on the content;
enable the use of lower end, or consumer version, GPUs for encoding, minimum computational resources at server/aggregator, and regular existing phone devices for delivering the high-resolution contents (up to 8k);
enable real-time efficient video streaming;
is transmission protocol-agnostic; and
provide seamless transition between different

resolutions from the end user point of view.

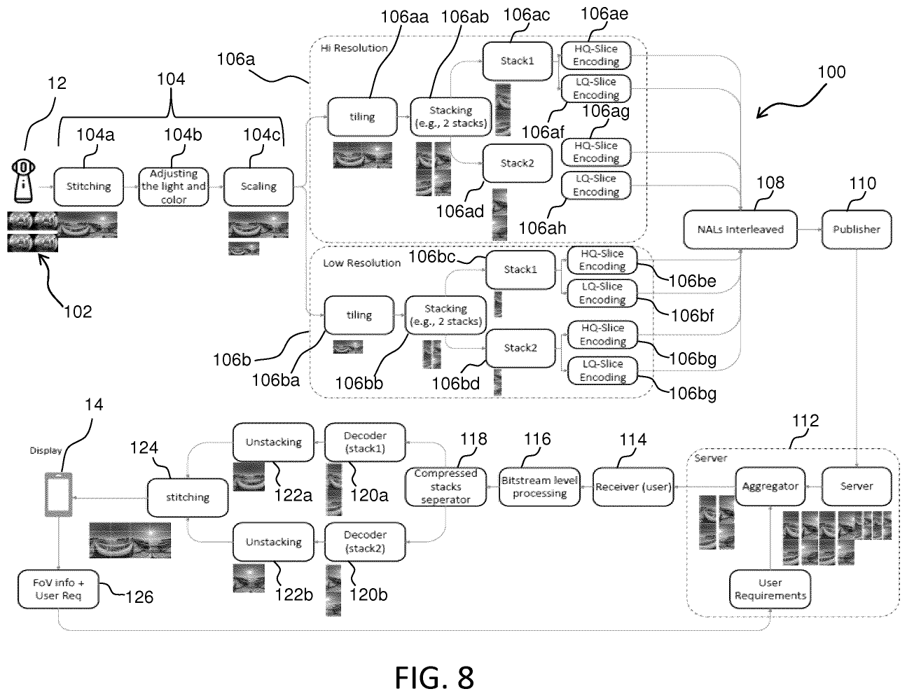

Referring now to FIG. 8, there is shown a flow diagram of the real-time multi-resolution video stream tile encoding process 100 in accordance with the illustrative embodiment of the present disclosure. Steps of the process 100, which uses selective tile delivery by aggregator-server to the client based on user position and depth requirements, are indicated by blocks 102 to 126.

The process 100 starts at block 102 where video input from camera 12 (capture) is obtained.

At block 104, the video input is pre-processed by the post processing module 24 (see FIG. 1), such as stitching 104a, light and color adjustment 104b, and scaling 104c.

Then, at block 106, the pre-processed video is separated into high 106a and low 106b resolution video, for example 8K and 4K video, which go through tiling 106aa, 106ba, stacking 106ab, 106bb, and is then separated into two stacks 106ac, 106ad, 106bc, 106bd (or in alternative embodiments 1 or more stacks), which are encoded by encoder 24 into high-quality slices 106ae, 106ag, 106be, 106bg, and low-quality slices 106af, 106ah, 106bf, 106bh.

At block 108, the high-quality and low-quality slices 106ae, 106ag, 106be, 106bg, 106af, 106ah, 106bf, 106bh are interleaved and, at block 110 published.

At block 112, the interleaved stream is aggregated by the aggregator module 32, producing a multi-quality tiled encoded 360 frame 34 in accordance with a point of view position signal 36 provided by the client device 38.

Then, at block 114, the multi-quality tiled encoded 360 frame stream 34 is received by the client device 38 and processed at the bitstream level at block 116, and then, at block 118, the interleaved high-quality and low-quality slices 106ae, 106ag, 106be, 106bg, 106af, 106ah, 106bf, 106bh are separated into their original stacks.

At block 120, each stack is decoded 120a, 120b, and at block 122 unstacked 122a, 122b, to be stitched back at block 124 and displayed on the end-user display 14 as a 360-degree frame 16.

Finally, at block 126, user FoV information and user requirements are provided to the aggregator module 32.

Although the present disclosure has been described with a certain degree of particularity and by way of an illustrative embodiments and examples thereof, it is to be understood that the present disclosure is not limited to the features of the embodiments described and illustrated herein, but includes all variations and modifications within the scope of the disclosure.

1. A method for real-time multi-resolution video stream tile encoding, comprising the steps of:
receiving a video feed;
performing stitching on the received video feed;
separating the stitched video feed into a high-resolution stitched video feed and a stitched low-resolution video feed;
for the high-resolution stitched video feed, performing the sub-steps of:
tiling the high-resolution stitched video feed;
stacking the tiled high-resolution stitched video feed into at least one stack;
slice encoding each of the at least one stack of tiled high-resolution stitched video feed into a high-quality slice encoded tiled high-resolution stitched video feed and a low-quality slice encoded tiled high-resolution stitched video feed;
for the low-resolution stitched video feed, performing the sub-steps of:
tiling the low-resolution stitched video feed;
stacking the tiled low-resolution stitched video feed into at least one stack;
slice encoding each of the at least one stack of tiled low-resolution stitched video feed into a high-quality slice encoded tiled low-resolution stitched video feed and a low-quality slice encoded tiled low-resolution stitched video feed;
interleaving the high-quality slice encoded tiled high-resolution stitched video feed, the low-quality slice encoded tiled high-resolution stitched video feed, the high-quality slice encoded tiled low-resolution stitched video feed and the low-quality slice encoded tiled low-resolution stitched video feed;
aggregating the interleaved video feed into a full frame video feed;
providing the aggregated interleaved video feed to a user device with a high-quality version or low-quality version according to received user requirements from the user device;
wherein the user device separates, decodes and unstacks each of the at least one stack, which are then stitched together and then played back through a display of the user device.

2. A method in accordance with claim 1, wherein the video feed is a high-quality and high-resolution video feed.

3. A method in accordance with claim 1, further comprising the steps of adjusting light and color, and performing scaling after the step of performing stitching on the received video feed.

4. A method in accordance with claim 1, wherein the user device pre-processes the received the aggregated interleaved video feed to determine any resolution changes; and then re-establish its decoding, stitching, and displaying respective to received resolution information without any interruption in the playback.

5. A method in accordance with any one of claims claim 1, wherein each of the high-resolution stitched video feed and the low-resolution stitched video feed are stacked in two stacks, each stack containing multiple tiles in a vertical format.

6. A system for real-time multi-resolution video stream tile encoding, comprising:
a user device including:
a user interface configured to provide user requirements;
a display;
a camera generating a video feed;
a streaming server including:
a capturing module configured to receive the video feed;
a pre-processing module configured to perform the step of:
stitching on the received video feed;
an encoder module configured to perform the steps of:
separating the stitched video feed into a high-resolution stitched video feed and a stitched low-resolution video feed;
for the high-resolution stitched video feed, performing the sub-steps of:
tiling the high-resolution stitched video feed;
stacking the tiled high-resolution stitched video feed into at least one stack;
slice encoding each of the at least one stack of tiled high-resolution stitched video feed into a high-quality slice encoded tiled high-resolution stitched video feed and a low-quality slice encoded tiled high-resolution stitched video feed;
for the low-resolution stitched video feed, performing the sub-steps of:
tiling the low-resolution stitched video feed;
stacking the tiled low-resolution stitched video feed into at least one stack;
slice encoding each of the at least one stack of tiled low-resolution stitched video feed into a high-quality slice encoded tiled low-resolution stitched video feed and a low-quality slice encoded tiled low-resolution stitched video feed;
interleaving the high-quality slice encoded tiled high-resolution stitched video feed, the low-quality slice encoded tiled high-resolution stitched video feed, the high-quality slice encoded tiled low-resolution stitched video feed and the low-quality slice encoded tiled low-resolution stitched video feed;
an aggregator server configured to perform the steps of:
aggregating the interleaved video feed into a full frame video feed;
providing the aggregated interleaved video feed to the user device with a high-quality version or low-quality version according to received user requirements from the user device;
wherein the user device separates, decodes and unstacks each of the at least one stack, which are then stitched together and then played back through the display of the user device.

7. A system in accordance with claim 6, wherein the camera generates a high-quality and high-resolution video feed.

8. A system in accordance with claim 6, wherein the pre-processing module is further configured to perform the steps of adjusting light and color, and performing scaling after the step of performing stitching on the received video feed.

9. A system in accordance with claim 6, wherein the user device is configured to pre-processes the received aggregated interleaved video feed to determine any resolution changes; and then re-establish its decoding, stitching, and displaying respective to received resolution information without any interruption in the playback.

10. A system in accordance with claim 6, wherein each of the high-resolution stitched video feed and the low-resolution stitched video feed are stacked in two stacks, each stack containing multiple tiles in a vertical format.

11. A method in accordance with claim 6, wherein the user interface is selected from a group consisting of a touch screen and motion sensors.
